(19) United States
(12) Patent Application Publication
(10) Pub. No.: US 2012/0213174 A1
(43) Pub. Date: Aug. 23, 2012

(54) Method and System for Optimizing Performance with Hitless Switching for Fixed Symbol Rate Carriers Using Closed-Loop Power Control while Maintaining Power Equivalent Bandwidth (PEB)

(75) Inventors: Vasile Manea, Potomac, MD (US); Naresh Jain, Tempe, AZ (US); Michael Beeler, Jefferson, MD (US); Wallace Davis, Scottsdale, AZ (US); Cris M. Mamaril, Mesa, AZ (US); Frederick Morris, Gaithersburg, MD (US); John Baddick, Gettysburg, PA (US)

(73) Assignee: COMTECH EF DATA CORP., Tempe, AZ (US)

(21) Appl. No.: 13/411,062

(22) Filed: Mar. 2, 2012

Related U.S. Application Data
(60) Provisional application No. 61/565,382, filed on Nov. 30, 2011.

(51) Int. Cl. H04W 72/04

(52) U.S. Cl. 370/329

(57) ABSTRACT

A method of controlling bandwidth allocation over a communications link comprising detecting, by a processor, a change in a power level of a composite signal transmitted by a transmitter, the composite signal comprising a plurality of carrier signals and having a constant center frequency and spectral allocation, adjusting at least one of a modulation factor and a forward error correction (FEC) rate of one or more of the plurality of carrier signals using a modulator, in response to the change in power level to maintain a predetermined data rate and spectral allocation of the composite signal, and maintaining, by the modulator, an uninterrupted communications link between the transmitter and a remote receiver while the at least one of the modulation factor and the FEC rate is adjusted.

### CROSS REFERENCE TO RELATED APPLICATIONS

This document claims the benefit of the filing date of U.S. Provisional Patent Application No. 61/565,382, entitled “A Method and System for Optimizing Performance with Hitless Switching for Fixed Symbol Rate Carriers Using Closed-Loop Power Control while Maintaining Power Equivalent Bandwidth (PEB)” to Vasile Manea et al., which was filed on Nov. 30, 2011, the disclosure of which is hereby incorporated entirely by reference herein.

### BACKGROUND

1. Technical Field

Aspects of this document relate generally to telecommunication systems and techniques for transmitting data across a telecommunication channel.

2. Background Art

A recurring problem continuing to challenge the communications industry is maintaining the power equivalent bandwidth (PEB) on repeating relays such as space-based satellite relays or airborne relays. Since amplifiers do not have an infinite amount of power, the available power is allocated over a given amount of spectrum (bandwidth) combined with a given power. The combination of bandwidth and power is known in the art as power equivalent bandwidth (PEB).

In satellite communications, the repeating relay's amplifier for a block of spectrum is known as a transponder. Typical transponders on a space-based satellite relay are usually, but not limited to, 36 MHz, 54 MHz or 72 MHz wide. PEB is established as the power used by the carrier signal or carrier signals divided by the transponder's saturated power:

Power Equivalent Bandwidth (“PEB”) for a carrier signal or carrier signals is expressed in MHz. PEB is the measure of the ratio of allocated power of the carrier against the total resources of the transponder. For example, 36 MHz PEB from a 72 MHz transponder represents 50% of the total transponder's Saturated Power.

A satellite user contracts with a satellite provider to obtain a given amount of bandwidth and then is assigned a PEB. Within the assigned bandwidth, the user may use the entire bandwidth as long as the PEB is not exceeded. However, should the user wish to reduce the bandwidth, a tradeoff may be made to increase the power.

So as to reduce the complexity and length of the Detailed Specification, and to fully establish the state of the art in certain areas of technology, Applicants herein expressly incorporate by reference all of the following materials identified in each numbered paragraph below.

U.S. Publication No. 2011/0021137 entitled “Method and Apparatus for Compensation for Weather-Based Attenuation in a Satellite Link”, published Jan. 27, 2011, to Shaul Laufer et.al.

International Publication No. WO/2009/130701 entitled “Method and Apparatus for Compensation for Weather-Based Attenuation in a Satellite Link”, published Oct. 29, 2009, to Shaul Laufer et.al.

U.S. Publication No. 2011/0003543 entitled “Methods and Apparatus for Compensation for Weather-Based Attenuation in a Satellite Link” published Jan. 6, 2011 to Shaul Laufer et.al.

International Publication No. WO 2009/130700 entitled “Method and Apparatus for Compensation for Weather-Based Attenuation in a Satellite Link”, published Oct. 29, 2009, to Shaul Laufer et.al.

ViperSat Data Sheets by Comtech EF Data, published in approximately 2003.

ViperSat User Guide MN-22156 r7 VMS by Comtech EF Data, published in approximately 1997.

Applicants believe that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicants will amend the specification to expressly recite the essential material that is incorporated by reference as allowed by the applicable rules.

### SUMMARY

Implementations of a method of controlling bandwidth allocation over a communications link may comprise detecting, by a processor, a change in a power level of a composite signal transmitted by a transmitter, the composite signal comprising a plurality of carrier signals and having a constant center frequency and spectral allocation, adjusting at least one of a modulation factor and a forward error correction (FEC) rate of one or more of the plurality of carrier signals using a modulator, in response to the change in power level to maintain a predetermined data rate and spectral allocation of the composite signal, and maintaining, by the modulator, an uninterrupted communications link between the transmitter and a remote receiver while at least one of the modulation factor and the FEC rate is adjusted.

Particular implementations may comprise one or more of the following features. The at least one of the modulation factor and the FEC rate of only one carrier signal among the plurality of carrier signals may be adjusted. The at least one of the modulation factor and the FEC rate of two or more carrier signals among the plurality of carrier signals may be adjusted. The method may further comprise reducing, by a single remote receiver, the power level and corresponding data rate required by the single remote receiver and reducing, by the modulator, the at least one of the modulation factor and FEC rate such that the communications link between the transmitter and single remote receiver remains a closed link. The method may further comprise reducing, by a plurality of remote receivers, the power level and corresponding data rate required by the plurality of remote receivers and reducing, by the modulator, the at least one of the modulation factor and FEC rate such that the communications links between the transmitter and the plurality of remote receivers remain closed links. The method may further comprise increasing, by a single remote receiver, the power level and corresponding data rate required by the single remote receiver and increasing, by the modulator, the at least one of the modulation factor and FEC rate such that the communications link between the transmitter and single remote receiver remains a closed link.

The method may further comprise increasing, by a plurality of remote receivers, the power level and corresponding data rate required by the plurality of remote receivers and increasing, by the modulator, the at least one of the modulation factor and FEC rate such that the communications links between the transmitter and the plurality of remote receivers remain closed links. The method may further comprise adjusting the at least one of the modulation factor and FEC rate using adaptive coding and modulation (ACM). The method may further comprise maintaining a power equivalent bandwidth (PEB) for a single carrier signal among the plurality of carrier signals. The method may further comprise maintaining a constant occupied bandwidth for each carrier signal among the plurality of carrier signals using a constant symbol rate configuration. The method may further comprise transmitting, by a hub, control information to one or more remote receivers, the control information comprising information about at least one of a required power level, modulation factor, and FEC rate. The method may further comprise maintaining a constant power equivalent bandwidth (PEB) for the composite carrier signal. The method may further comprise adjusting the at least one of the modulation factor and FEC rate using adaptive coding and modulation (ACM).

The method may further comprise maintaining a constant occupied bandwidth for each carrier signal among the plurality of carrier signals using a constant symbol rate configuration and adjusting a power level of the transmitter such that the composite carrier signal has a PEB that is equal to or less than a maximum allowable PEB. The method may further comprise transmitting, by a hub, control information to one or more remote receivers, the control information comprising information about at least one of a required power level, modulation factor, and FEC rate. The method may further comprise monitoring, by a plurality of remote receivers, a PEB of the plurality of carrier signals and controlling, by each of the remote receivers among the plurality of remote receivers, at least one of a power level, modulation factor and FEC rate of the remote receiver based on a contribution to the PEB of the plurality of carrier signals made by the remote receiver. The method may further comprise determining an optimal combination of power level and data rate for a remote receiver based on a predetermined data rate and one or more network requirements.

The method may further comprise measuring, by a hub, a power contribution of each remote receiver and adjusting, by the hub, at least one of the power level, modulation factor, and FEC rate of one or more remote receivers to achieve a predetermined PEB for the network. The method may further comprise measuring, by a hub, a required bandwidth request of each remote receiver and adjusting, by the hub, at least one of the power level, modulation factor, and FEC rate of one or more remote receivers to achieve a predetermined PEB and data rate for the network. The method may further comprise adjusting one or more filter roll-offs or excess bandwidth of one or more carrier signals while maintaining a power equivalent bandwidth (PEB) of the one or more carrier signals. The method may further comprise increasing a power level of one or more remote transmitters by adjusting at least one of a power level, modulation factor, and FEC rate of a hub. The method may further comprise receiving, by a hub, information about a PEB of a network from an external measuring device. The method may further comprise receiving by one or more remote receivers, information about a PEB of a network from an external measuring device. The method may further comprise receiving, by a hub, information about a PEB of a network from an external measuring device and receiving by one or more remote receivers, information about the PEB of the network from the external measuring device.

Implementations of a system for controlling bandwidth allocation over a communications link may comprise a transmitter, a remote receiver a processor configured to detect a change in a power level of a composite signal transmitted by the transmitter, the composite signal comprising a plurality of carrier signals and having a constant center frequency and spectral allocation, and a modulator configured to adjust at least one of a modulation factor and a forward error correction (FEC) rate of one or more of the plurality of carrier signals in response to the change in power level to maintain a predetermined data rate and spectral allocation of the composite signal, and maintain an uninterrupted communications link between the transmitter and the remote receiver while the at least one of the modulation factor and the FEC rate is adjusted.

Particular implementations may comprise one or more of the following features. The modulator may be further configured to adjust the at least one of the modulation factor and the FEC rate of only one carrier signal among the plurality of carrier signals. The modulator may be further configured to adjust the at least one of the modulation factor and the FEC rate of two or more carrier signals among the plurality of carrier signals. The remote receiver may be a single remote receiver and is configured to reduce the power level and corresponding data rate required by the single remote receiver, and wherein the modulator is further configured to reduce at least one of the modulation factor and FEC rate such that the communications link between the transmitter and single remote receiver remains a closed link. The remote receiver may comprise a plurality of remote receivers that are configured to reduce the power level and corresponding data rate required by the plurality of remote receivers, and wherein the modulator is further configured to reduce at least one of the modulation factor and FEC rate such that the communications links between the transmitter and plurality of remote receivers remain a closed links.

The remote receiver may be a single remote receiver and is configured to increase the power level and corresponding data rate required by the single remote receiver, and wherein the modulator is further configured to increase at least one of the modulation factor and FEC rate such that the communications link between the transmitter and single remote receiver remains a closed link. The remote receiver may comprise a plurality of remote receivers that are configured to increase the power level and corresponding data rate required by the plurality of remote receivers, and wherein the modulator is further configured to increase at least one of the modulation factor and FEC rate such that the communications links between the transmitter and plurality of remote receivers remain closed links. The modulator may be further configured to adjust the at least one of the modulation factor and FEC rate using adaptive coding and modulation (ACM).

The modulator may be further configured to maintain a power equivalent bandwidth (PEB) for a single carrier signal among the plurality of carrier signals. The modulator may be further configured to maintain a constant occupied bandwidth for each carrier signal among the plurality of carrier signals using a constant symbol rate configuration. The system may further comprise a hub configured to transmit control information to one or more remote receivers, the control information comprising information about at least one of a required power level, modulation factor, and FEC rate. A constant power equivalent bandwidth (PEB) for the composite carrier signal may be maintained. The modulator may be further configured to adjust the at least one of the modulation factor and FEC rate using adaptive coding and modulation (ACM). The modulator may be further configured to maintain a constant occupied bandwidth for each carrier signal among the plurality of carrier signals using a constant symbol rate configuration, and adjust a power level of the transmitter such that the composite carrier signal has a PEB that is equal to or less than a maximum allowable PEB. The system may further comprise a hub configured to transmit control information to one or more remote receivers, the control information comprising information about at least one of a required power level, modulation factor, and FEC rate.

The system may further comprise a plurality of remote receivers configured to monitor a PEB of the plurality of carrier signals and control at least one of a power level, modulation factor and FEC rate of the remote receiver based on a contribution to the PEB of the plurality of carrier signals made by the remote receiver. The remote receiver may be configured to determine an optimal combination of power level and data rate for the remote receiver based on a predetermined data rate and one or more network requirements. The system may further comprise a hub configured to measure a power contribution of each remote receiver and adjust at least one of the power level, modulation factor, and FEC rate of one or more remote receivers to achieve a predetermined PEB for the network. The system may further comprise a hub configured to measure a required bandwidth request of each remote receiver and adjust at least one of the power level, modulation factor, and FEC rate of one or more remote receivers to achieve a predetermined PEB and data rate for the network.

The hub may be further configured to increase a power level of one or more remote transmitters by adjusting at least one of a power level, modulation factor, and FEC rate of the hub. The modulator may be further configured to adjust one or more filter roll-offs or excess bandwidth of one or more carrier signals while maintaining a power equivalent bandwidth (PEB) of the one or more carrier signals. The hub may be further configured to receive information about a PEB of a network from an external measuring device. The system may further comprise one or more remote receivers configured to receive information about a PEB of a network from an external measuring device. The hub may be further configured to receive information about a PEB of a network from an external measuring device and wherein one or more remote receivers is configured to receive information about the PEB of the network from the external measuring device.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶6. Thus, the use of the words “function,” “means” or “step” in the Description, Drawings, or Claims is not intended to somehow indicate a desire to invoke the special provisions of 35 U.S.C. §112, ¶6, to define the invention. To the contrary, if the provisions of 35 U.S.C. §112, ¶6 are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶6. Moreover, even if the provisions of 35 U.S.C. §112, ¶6 are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

FIG. 1 is a representation of a geographically diverse satellite network with a hub earth station terminal communicating with multiple remote sites.

FIG. 2 is a representation of an implementation of a satellite repeating relay.

FIG. 3 is a representation showing a typical satellite implementation comprising multiple transponders of two polarizations.

FIG. 4A is a spectral representation showing carrier signals of the same bandwidth allocation at the same power level resulting in a baseline PEB for the allocated spectrum.

FIGS. 4B-4C are spectral representations showing carrier signals of the same bandwidth but different power levels and the same PEB as the baseline configuration.

FIG. 5A is a spectral representation showing carrier signals of the same bandwidth allocation at the same power level using MODCOD 5 (8-QAM 0.642 FEC) that requires 20 Watts of power resulting in a baseline PEB for the allocated spectrum.

FIG. 5B is a spectral representation showing carrier signals of the same bandwidth allocation with the first, second, third and fifth at MODCOD 4 (QPSK 0.803 FEC) that requires 13.8 Watts of power that have been lowered to compensate for the fourth carrier at MODCOD 8 (16 QAM 0.731 FEC) that requires 44.7 Watts of power that has been raised to provide higher data rate resulting in a baseline PEB for the allocated spectrum.

FIG. 5C is a spectral representation showing carrier signals of the same bandwidth allocation with the first, second, third at MODCOD 2 (QPSK 0.631 FEC) that requires 5.5 Watts of power that have been lowered to compensate for the fourth and fifth carriers at MODCOD 7 (8-QAM 0.780 FEC) that requires 36.8 Watts of power that have been raised to provide higher data rate resulting in a baseline PEB for the allocated spectrum.

FIG. 6 shows a representation of balance of bandwidth and power with the optimal operating point where bandwidth and power are balanced.

FIG. 7 shows an implementation of various modulation and FEC modulation and coding combinations (MODCOD) of a particular MODCOD configuration and the associated Eb/No and Es/No required to close the link.

### DESCRIPTION

This disclosure, its aspects and implementations, are not limited to the specific components, frequency examples, or methods disclosed herein. Many additional components and assembly procedures known in the art consistent with a method and system for optimizing performance with hitless switching for fixed symbol rate carriers using closed-loop power control, while maintaining power equivalent bandwidth techniques are in use with particular implementations from this disclosure. Accordingly, for example, although particular implementations are disclosed, such implementations and implementing components may comprise any components, models, versions, quantities, and/or the like are known in the art for such systems and implementing components, consistent with the intended operation.

This disclosure relates to methods and systems for optimizing performance with hitless switching for fixed symbol rate carrier signals using closed-loop power control, while maintaining power equivalent bandwidth. Implementations of the methods provide the user with the ability to control bandwidth (e.g. raise or lower bandwidth) by increasing or decreasing the site or site's available power. Implementations of the methods make provisions for making power adjustments for data rate control that is above and beyond what is used in the current art for simply maintaining link availability. Implementations of the methods and systems provide a control mechanism in a manner in which the symbol rate is remains constant, resulting in no interruption to service as is required in the existing art.

Networks can be configured to operate as Constant-Coding and Modulation (CCM), in which the symbol rate is fixed and FEC modulation and coding (MODCOD) is also fixed and remains constant. In this configuration, the MODCOD must be established to operate in the worst case link conditions all the times thereby resulting in a less than optimal use of bandwidth. Variable Coding and Modulation (VCM) provides a fixed or a priori configuration of a fixed symbol rate and limited number of FEC coding and modulation formats that are supported. Sites are statically assigned to a given MODCOD in the VCM configuration. Adaptive Coding and Modulation (ACM) provides a fixed symbol rate and dynamic FEC coding and modulation formats. In all formats (CCM, VCM, and ACM), the symbol rate is fixed.

The ability to increase or decrease return channel performance may be accomplished in a manner that holds bandwidth constant (required symbol rate from each remote site), but power may be adjusted up or down on a site-to-site basis to increase or decrease the individual site's return channel rate using power alone. If the power is increased, then the MODCOD may be increased (higher modulation index and more efficient FEC) resulting in higher bits per second per Hertz (bps/Hz), thus increasing the throughput from the site. The power may be adjusted on the sites but constant monitoring must be done to ensure that the combined total power from the sites does not exceed the total assigned PEB.

This disclosure relates to, but is not limited to, implementations of a method and system for optimizing performance with hitless switching for fixed symbol rate carrier signals using closed-loop power control, while maintaining power equivalent bandwidth techniques. For point-to-point, point-to-multipoint and multipoint-to-multipoint networks that utilize a repeating relay such as a space-based satellite repeating relay or an airborne repeating relay, the amount of power allocated to a user or group of users to form a network may be allocated to ensure that the amount of power that is received and relayed from the relay does not cause the amplifier to become saturated. In satellite communications, a satellite is broken down into individual amplifiers that cover part of the spectrum and only amplify that portion. These are known as transponders. For a typical communications satellite that covers 500 MHz in two polarizations, the entire 500 MHz is broken down into 36, 54 or 72 MHz sections that cover each polarization. A typical satellite contains 12 transponders on the horizontal polarization and 12 transponders on the vertical polarization, so an entire band such as C-Band, X-Band, Ku-Band, etc. would require 24 transponders per band per satellite to cover 500 MHz over both polarizations.

Within a transponder, regardless of whether it has 36, 54, or 72 MHz sections, careful planning must be maintained to ensure the transponder's amplifiers are not over driven, resulting in them being driven into saturation. Saturation is also known as compression. “PldB” is defined as an operation point of the amplifier, when the transponder's output signal is one (1) Decibel (dB) compressed for more than one (1) dB of input power increasing. Satellite operators carefully monitor the amount of power that each transponder is supporting and the amount of frequency spectrum each assigned carrier signal occupies. When a customer purchases services from a transponder, two aspects (quantities) are assigned: power and bandwidth. The combination of the two is known in the art as the power bandwidth or Power Equivalent Bandwidth (PEB).

For the given carrier signal, the ability to support a given data rate (a result of symbol rate) is limited by the amount of power the transmitting earth station or transponder can support. To provide a higher data rate, the power must be raised and this results in a great ability to support a higher data rate. In the art, changing the modulation and Forward Error Correction (FEC) rate can be adjusted while changing the power resulting in higher data rates being supported, while holding the symbol rate constant. Changing the data rates with no regard to the PEB results in the bandwidth consumed on the transponder being held constant, but the power level must be increased. The resulting carrier signals flowing through the transponder would then be able to increase the modulation factor and use less FEC (less FEC bits and more user data) resulting in higher spectral efficiency (bits/Hertz), but with no regard to the number of sites increasing power, the result would be that the combined power would increase to a point where the power part of the PEB is exceeded.

Implementations of the method disclosed herein provide a hitless bandwidth control system based on increasing or decreasing the power from a remote terminal and then adjusting the modulation and coding as a result of more power being allocated or reduced in a manner that still closes the link, but does not cause an outage as a result of the increase or decrease of power. Power allocation is done by a process in the hub earth station as a result of bandwidth requested by the remote terminals or a scheduled event.

A particularly advantageous aspect is found in providing a mechanism that allows individual carrier signals to have their power levels adjusted resulting in the ability of achieving higher modulation factors while using less FEC, thereby resulting in higher spectral efficiency (bits/Hertz) and higher data rates while not experiencing carrier signal symbol rate changes (e.g. losses due to rate switches) and ensuring that the total available PEB is not exceeded. Another particularly advantageous aspect is that all carrier signals are managed in a manner such that the occupied bandwidth of the satellite is held constant and the amount of power is dynamically assigned by request to the carrier signals which request a higher data rate, such that available PEB is shared among the users. The allocation of power is achieved to ensure that remotes that need additional throughput are given more power which results in a higher modulation factor and lower FEC for a higher user data rate and a higher spectral efficiency (bits/Hertz). Additionally, the sites that do not need a higher rate are allowed to lower their power resulting in a lower modulation factor and higher FEC for a lower data rate and higher spectral efficiency (bits/Hertz) while the PEB is less than or equal to the total contractual value provided by the leased bandwidth contract with the satellite operator.

Particular implementations for a method and system for optimizing performance with hitless switching for fixed symbol rate carrier signals using closed-loop power control, while maintaining power equivalent bandwidth techniques disclosed herein may be specifically employed in satellite communications systems. However, as will be clear to those of ordinary skill in the art from this disclosure, the principles and aspects disclosed herein may readily be applied to any electromagnetic (IF, RF and optical) communications system, such as terrestrial broadcast network without undue experimentation.

The need to balance allocated bandwidth versus the available power for a repeating relay is not by itself a novel concept. As cited in the disclosure, there are numerous techniques that have been developed as to ensure the power bandwidth or as known in the art, Power Equivalent Bandwidth (PEB), is preserved. At the time of this disclosure, all methods of controlling PEB are done as a way of to maintaining bandwidth to or from a location. Implementations of the described methods introduce the ability to provide a hitless way to increase and decrease data rate within a pool of bandwidth by increasing the power to sites that desire or request more data rate by increasing the available power, resulting in the ability to achieve a higher modulation factor and lowering the amount of FEC overhead resulting in higher spectral efficiency (bits/Hertz), which ultimately results in higher user data throughput. As a consequence of the raising a site's or sites' power to maintain the PEB while holding the allocated bandwidth constant, other sites must have their power lowered. As a consequence of lowering the power to the sites that do not need higher data rate, as the power is lowered, the modulation factor and/or FEC overhead must be increased to keep the link closed. This balance between the power allocated to each site results in a method to maintain the PEB at a constant value.

In the art, the PEB is a number that represents two factors: firstly, the bandwidth of the transponder as a percentage of the entire pass band; and secondly, a percentage of available power. The combined number is represented as a total percentage of the transponder's bandwidth combined with the available power.

As an example, suppose a customer desires to operate on a 36 MHz satellite transponder equipped with a 100-Watt amplifier, and wishes to use only 10 MHz of satellite spectrum. Based on the size of the carrier signal and the transmission equipment, a PEB of 10 MHz is assigned to the carrier. The PEB of 10 MHz relates to 10/36 or 27.77% of the available power of the transponder. This results in 27.77 Watts from the 100 Watts of total available transponder power (resource) are used for this 10 MHz carrier.

As a second example, suppose a customer desires to operate on a 36 MHz satellite transponder equipped with a 100 Watt amplifier, and wishes to use only 10 MHz of satellite spectrum, but needs two times the power as stated in the first example. Based on the size of the carrier signal and the transmission equipment, a PEB of 20 MHz is assigned to the carrier. The PEB of 20 MHz relates to 20/36 or 55.55% of the total available power or 55.55 Watts from the total 100 Watts available. The 10 MHz spectrum represents 10/36 or 27.77% of the available physical bandwidth of the transponder. The required bandwidth for this 10 MHz wide carrier is 20 MHz because the required PEB is (10+10)/36 or 20/36 for a PEB of 55.55% or 55.55 Watts.

As a third example, suppose a customer desires to operate on a 72 MHz satellite transponder equipped with a 100-Watt amplifier, and wishes to use only 10 MHz of satellite spectrum, but needs 50% of the power of the transponder. Based on the size of the carrier, 10 MHz/72 MHz is assumed based on bandwidth and 50% of the power is 36 (based 36/72), or 50 Watts. The 10 MHz wide carrier relates to 10/72 or 13.88% of the available bandwidth and 36/72 or 50.00% of the available power of the transponder (50 Watts). The requirement for this service is 36 MHz even the occupied bandwidth is 10 MHz and 26 MHz physical bandwidth is not used.

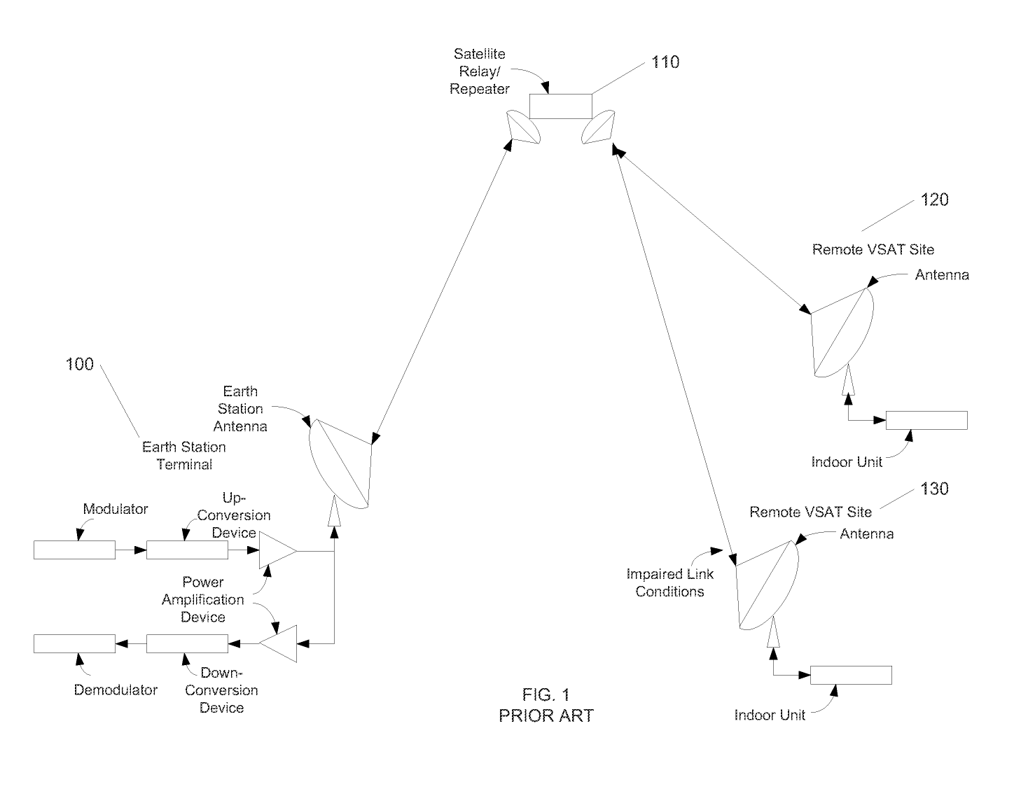

FIG. 1 shows a typical satellite configuration where three sites, a hub earth station terminal 100 is communicating over a satellite repeating relay 110 to two geographically diverse remote sites 120, 130.

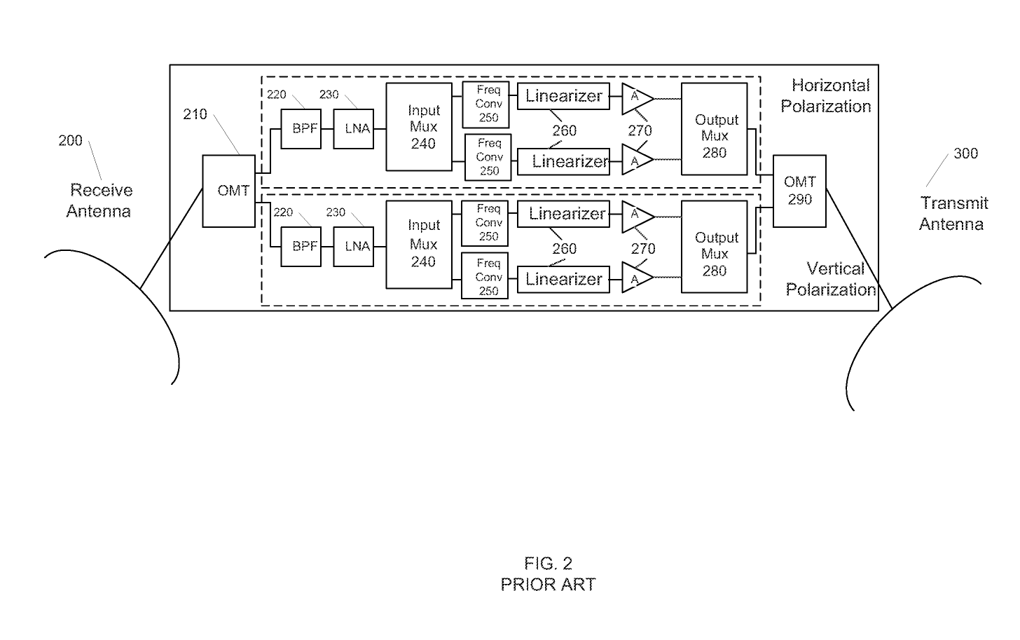

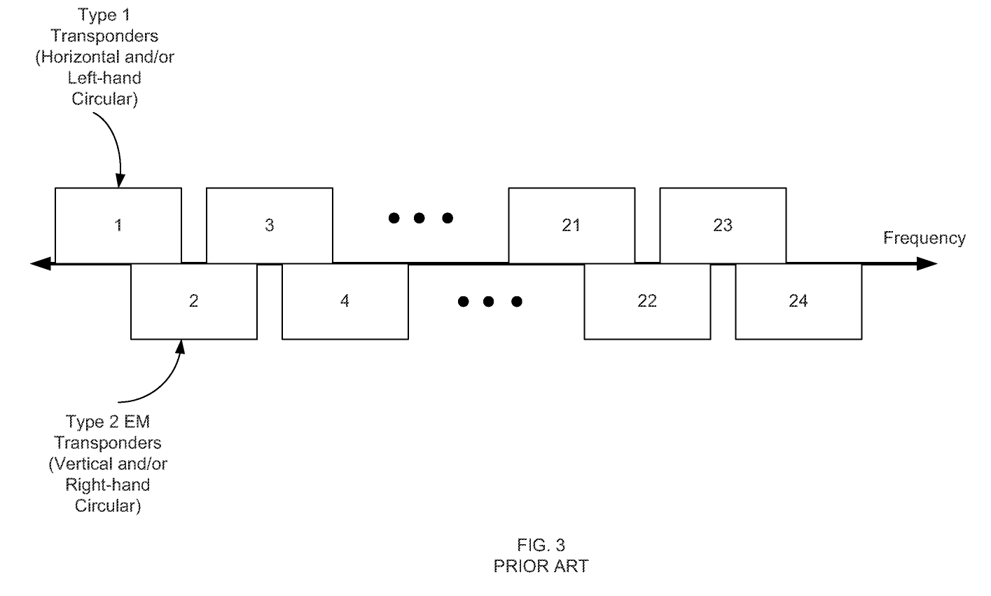

FIG. 2 illustrates a typical satellite based repeating relay used in the art with no onboard processing. The repeating relay comprises an input (receive antenna) 200 which receives the incoming carrier signals, Orthogonal Mode Transducer (OMT) 210 that separates the various electromagnetic (EM) polarizations, Bandpass Filters (BPF) 220 that filter the frequency spectrum, a Low-Noise Amplifier (LNA) 230 that allows the received carrier signals to be power amplified, a multiplexer 240 which separates the various frequency spectra to the appropriate transponder and a frequency converter 250 to convert to the downlink frequency. The repeating relay further linearizes 260 any non-linearity due to the amplifiers, amplifies 270 before transmitting back to the destination, multiplexes 280 to the proper EM polarization configuration and feeds to the OMT 290 to the transmit antenna 300 feed for relay. The configuration of the transponders of the repeating relay may be comprised of a single transponder or a plurality of EM transponders with or without overlapping frequencies as shown in FIG. 3.

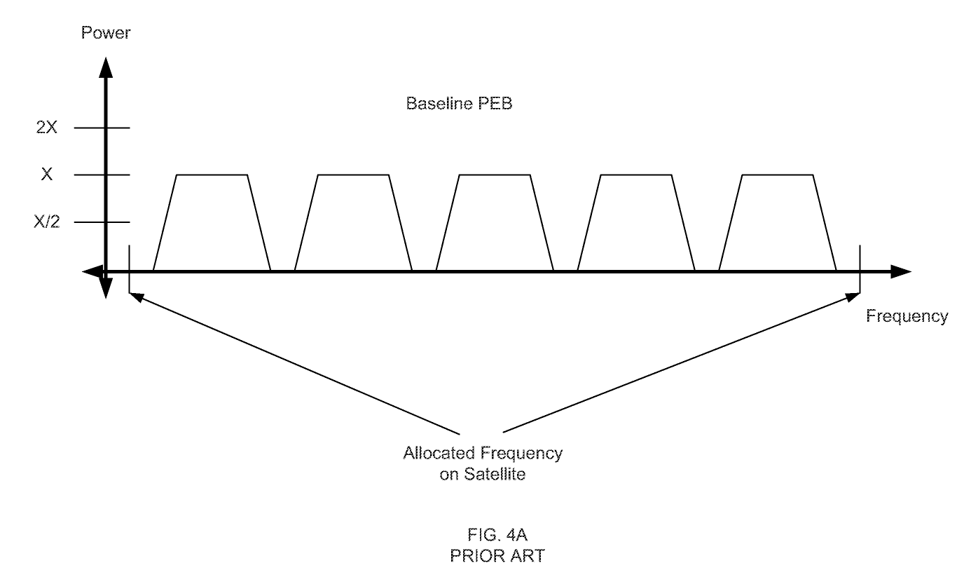

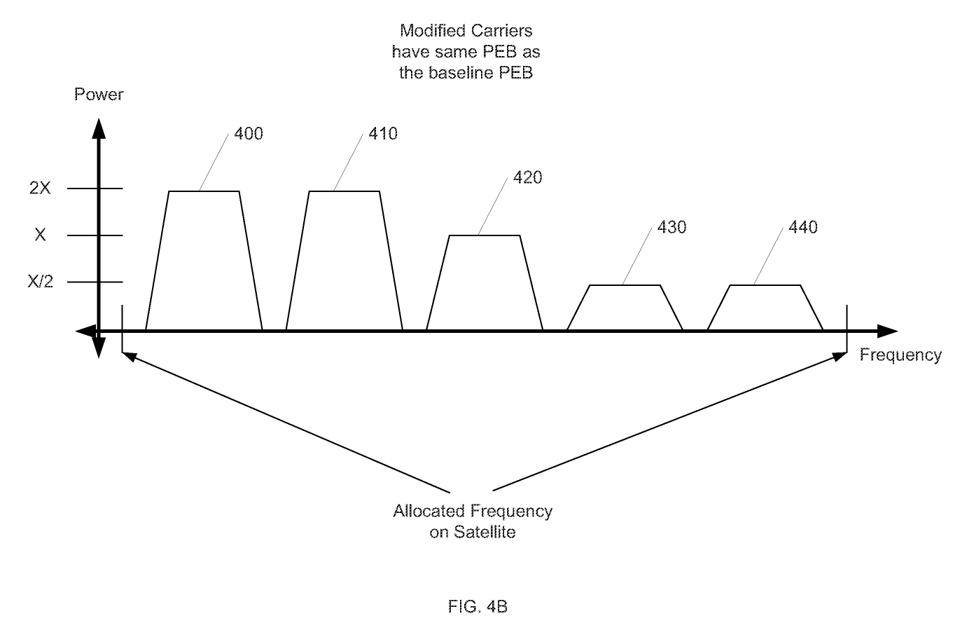

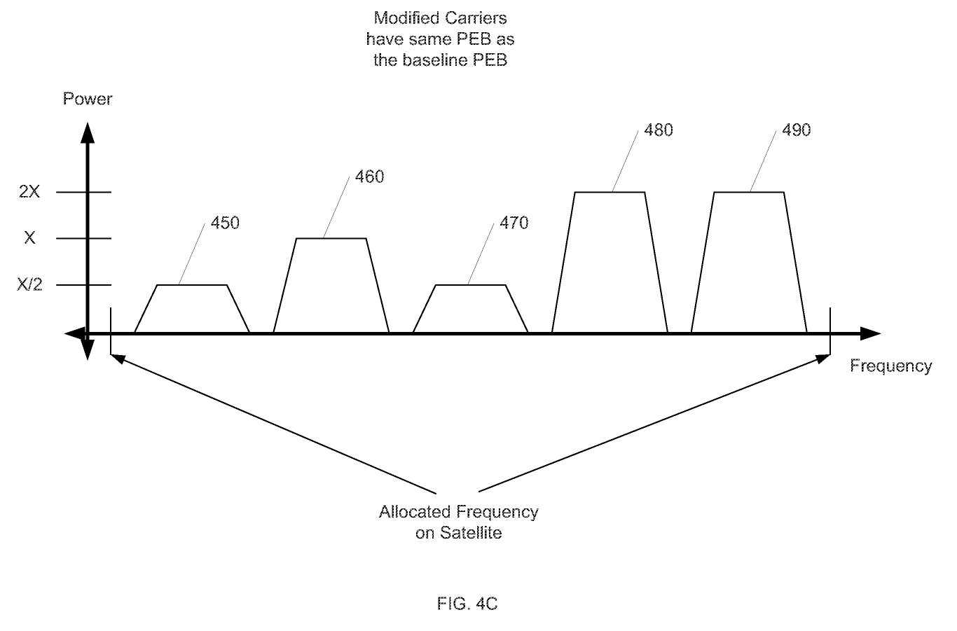

FIG. 4A shows the prior art in which all of the carrier signals are normalized and held constant to an X Watts power level. In the prior art, if one carrier signal's power is raised, then the satellite operator must be contacted and the site must be moved or additional considerations in the form of funds or other carrier signals on the allocated spectrum must be manually adjusted to compensate for the increase in power. FIG. 4A may also be considered as the home state of an implementation of the described method in which five carrier signals are all set to the same power level, modulation factor and FEC coding rate. The result is that all sites provide equal throughput to the user (user data rate). With all carriers set to the same bandwidth and power over the allocated spectrum, the PEB is established as the baseline.

FIG. 4B shows the result of two sites (carrier signals one and two) 400, 410 requiring more bandwidth, and carrier signal three 420 remains set at baseline. However, to compensate for the increase in power on carrier signals one and two, carrier signals four 430 and five 440 must be lowered by an equal amount, resulting in less user data throughput. An advantageous aspect is that the symbol rate (occupied bandwidth) does not change. Since the symbol rate does not have to be changed, and only the power is increased or decreased, the effect of the modulation factor or FEC coding resulting in higher spectral efficiency (bits/Hertz) to change the increase in data rate to the user is completely hitless resulting in no power carrier outage for retuning the transmitter or receiver hardware. The net result is no loss in bandwidth or time due to an outage from going from one modulation factor or FEC coding rate to another. Another advantageous aspect is that the PEB is monitored and controlled, resulting in the net PEB remaining constant.

FIG. 4C shows the result of two sites (carriers four and five) 480, 490 requiring more bandwidth while carrier 460 two remains set at baseline. However, to compensate for the increase in power on carriers four 480 and five 490, the power level of carrier signals one 450 and three 470 must be lowered by an equal amount, resulting in less user data throughput.

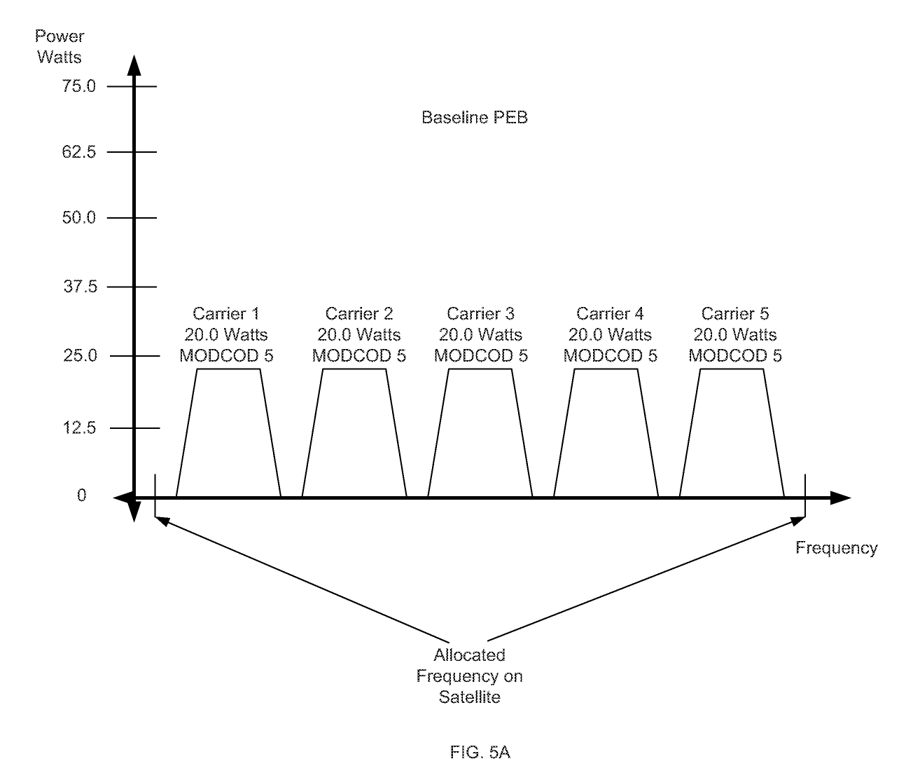

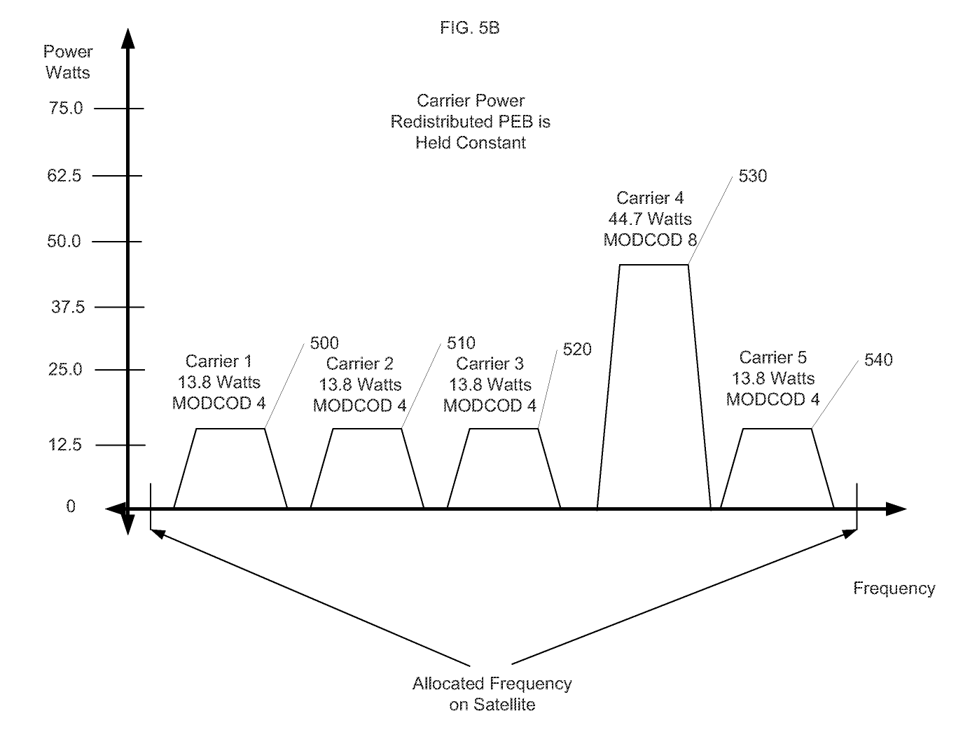

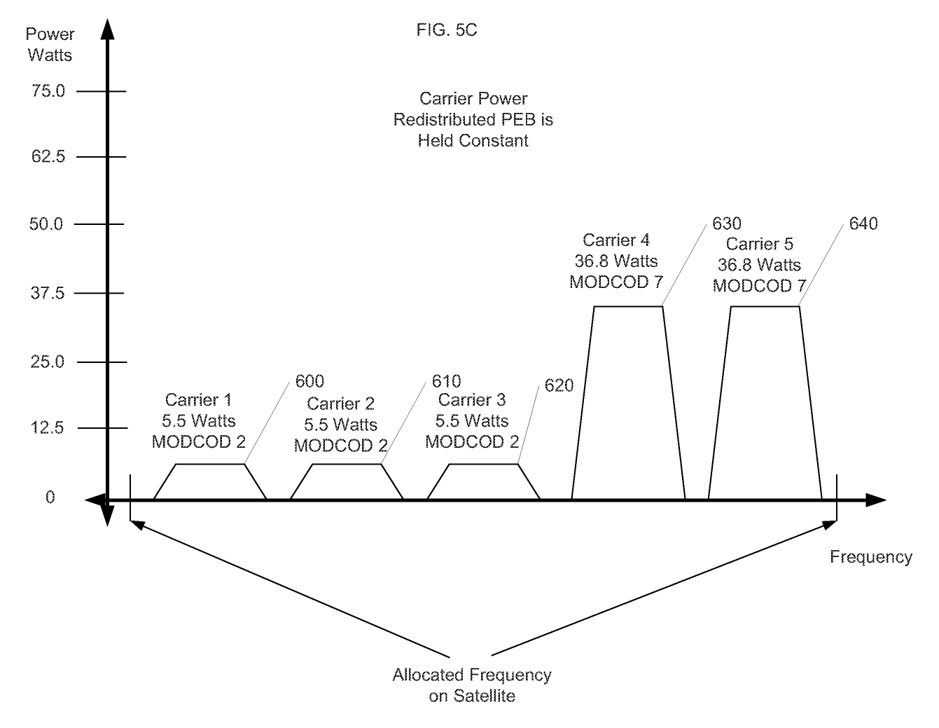

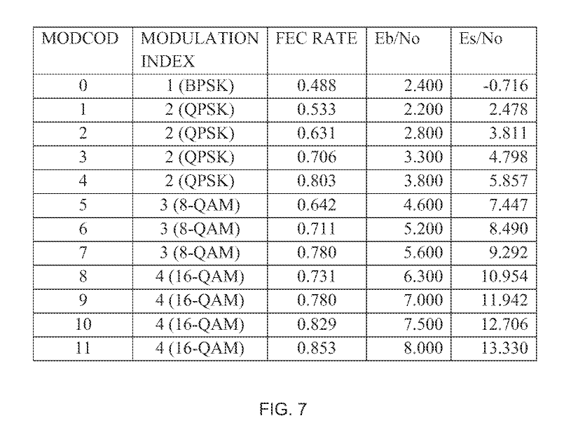

As more detailed examples, FIGS. 5A-5C demonstrate implementations of the described method using QPSK, 8-QAM, and 16-QAM modulation and a FEC known as VersaFEC based on a short block Low Density Parity Check (LDPC) code is shown in FIG. 7. While VersaFEC and LDPC are shown here for exemplary purposes, one of ordinary skill in the art would recognize that any appropriate modulation and coding format may also be used. For FIGS. 5A-5C, the PEB that is allocated is limited to 100 Watts. The result of the technique as described in FIG. 5A assumes, for simplicity, the combined power is 100 Watts based on the power of each carrier. FIG. 5A shows that the combined power is 5*20 Watts=100 Watts.

FIG. 5B shows carrier signal four 530 requires more bandwidth. In a hitless manner, the power is lowered on carrier signals one 500, two 510, three 520, and five 540 and then carrier signal four's 530 power is increased. As a result of the changes, the MODCOD is lowered from 5 to 4 on carrier signals one 500, two 510, three 520, and five 540, and carrier signal four 530 has the MODCOD raised to 8. The result is that carrier signal four 530 may provide higher throughput for the duration that the carrier signal's power is increased. The combined power is 4*13.8 Watts+1*44.7 Watts=99.9 Watts which remains below the allocated 100 Watts of PEB. Unlike the prior art, this implementation of the described method is used to adjust (raise or lower) the throughput to the site, not simply to maintain the data rate.

FIG. 5C shows carrier signals four 630 and five 640 require more bandwidth. In a hitless manner, the power is lowered on carrier signals one 600, two 610, and three 620 and then carrier signals four 630 and five's 640 power is increased. As a result of the changes, the MODCOD is lowered from 5 on 2 on carrier signals one 600, two 610, and three 620, and carrier four 630 and five 640 have the MODCOD raised to 7. The result is that carrier signals four 630 and five 640 may provide higher throughput for the duration that the power of the carrier signals is increased. The combined power is 3*5.5 Watts+2*36.8 Watts=90.22 which remains below the allocated 100 Watts of PEB. Unlike the prior art, the described method is used to adjust (raise or lower) the throughput to the site, not simply to maintain the data rate.

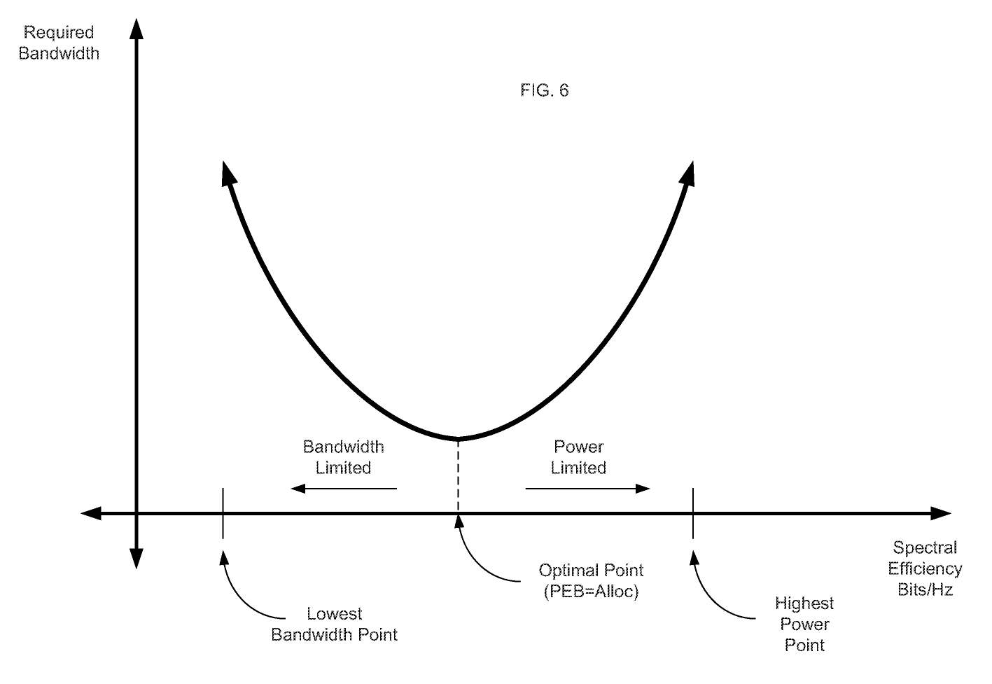

FIG. 6 shows how the bandwidth and power relate to one another. The curve is dependent on the size of the antenna, electronics (size and linearity of the amplifiers), location of the site within the beam of the satellite, performance of the satellite, environmental condition, etc. For a network design that does not change modulation or FEC, known in the art as Constant Coding and Modulation (CCM), the null of the curve is the point at which the PEB is optimal, and where a CCM network is operated. However, with the introduction of the Adaptive Coding and Modulation (ACM) and Variable Coding and Modulation (VCM), the modulation and FEC coding may be adjusted to move the spectral efficiency up and down the curve. When operating with low power, the FEC must be increased providing more coding gain to compensate for the lower power. The result as is shown on the graph is that as the efficiency begins to decrease, the corresponding bandwidth must increase if the desired throughput must remain the same. If the bandwidth does not increase, the user throughput naturally begins to decrease. In implementations of the described method, the bandwidth may decrease both to the minimum rate and below the minimum rate. Conversely, as additional bandwidth is desired, the efficiency increases as power is added and the amount of FEC may be reduced, thus providing more user throughput for carrying data. In this configuration, the available data rate may be higher than the minimum rate. If the bandwidth is held constant, the user will realize more bandwidth by the increase in power just by increasing the modulation index and reducing the amount of FEC overhead.

In an embodiment of described method, the available power allocation pool may be operated at peak operation all the time and every site is configured to meet a minimum rate plus any additional power that may be available resulting in the PEB being fully optimized. This mode of operation allows sites to have additional bandwidth (above the minimum rate) available to one, some or all sites.

In an alternate embodiment of the described method, the available power allocation pool may be operated at less than peak PEB operation and when a particular site or sites desires additional bandwidth above the required minimum rate, additional power is allocated to the site or sites for the duration of operation above the minimum rate. When operating in the increased power mode, the PEB may operate at peak or below peak allocation.

In an additional alternative embodiment of the describe method, the available power allocation pool may be operated at less than peak PEB operation resulting in sites being operated at or below the required minimum rate (as long as user data traffic continues to be supported), and when a particular site or sites desires additional bandwidth, then additional power is allocated to the site for the duration of operation to meet the desired data needs.

The following are particular implementations utilizing a method and system for optimizing performance with hitless switching for fixed symbol rate carriers using closed-loop power control, while maintaining power equivalent bandwidth techniques and are provided as non-limiting examples:

### EXAMPLE 1

A satellite network is configured to operate a hub-spoke Very Small Aperture Terminal (VSAT) with a signal hub earth station and ten remote sites over a C-Band geostationary satellite repeating relay with 36 MHz transponders. The allocated satellite bandwidth is 18 MHz and each carrier signal is assigned to operate with 1.8 MHz of spectrum. The bandwidth is allocated as 18 MHz/36 MHz or 50.00% and the power is allocated at the same number (18/36) 50.00%. In the baseline configuration, each site uses 5.00% of the allocated PEB. For the example, one site requires an increase in bandwidth resulting in the power having to be increased to the one site of 25.00%. The result will be half of the PEB will need to be allocated to this one site while the remaining sites being decreased by this amount. The redistribution of power is: power to the high bandwidth site being 25.00% and 2.77% to the remaining nine sites. Therefore, the power is distributed as 25.00%+9*2.77%=49.93% of the power, which maintains the PEB to the contracted amount. When the power is adjusted and the MODCODs are changed, no interruption to the service is experienced.

### EXAMPLE 2

In particular implementations of the system described in Example 1, the satellite uses X-Band resulting in the same allocation of PEB.

### EXAMPLE 3

In particular implementations of the system described in Example 1, the satellite uses Ku-Band resulting in the same allocation of PEB.

### EXAMPLE 4

In particular implementations of the system described in Example 1, the satellite uses Ka-Band resulting in the same allocation of PEB.

### EXAMPLE 5

A satellite network is configured to operate a hub-spoke Very Small Aperture Terminal (VSAT) with a signal hub earth station and five remote sites over Ku-Band geostationary satellite repeating relay with 72 MHz transponders. The allocated satellite bandwidth is 18 MHz and each carrier signal is assigned to operate with 3.6 MHz of spectrum. The bandwidth is allocated as 18/72 MHz or 25.00%. However, the power is allocated at 50.00% of the available power of the transponder. The net result is that the PEB is allocated at 18+36/72 or 54/72=75.00%. In the baseline configuration, each site uses 15.00% of the allocated PEB. For this example, one site requires an increase in bandwidth resulting in the power having to be increased to the one site of 50.00%. The result is half of the PEB will need to be allocated to this one site while the remaining sites are decreased by this amount. The redistribution of power is: power to the high bandwidth site being 37.50% and 9.37% to the remaining four sites. Therefore, the power would be distributed as 37.50%+4*9.37%=74.98% of the power, which maintains the PEB to the contracted amount. When the power is adjusted and the MODCODs are changed, no interruption to the service is experienced.

### EXAMPLE 6

In particular implementations of the system described in Example 5, the satellite uses C-Band resulting in the same allocation of PEB.

### EXAMPLE 7

In particular implementations of the system described in Example 5, the satellite uses X-Band resulting in the same allocation of PEB.

### EXAMPLE 8

In particular implementations of the system described in Example 5, the satellite uses Ka-Band resulting in the same allocation of PEB.

### EXAMPLE 9

A satellite network is configured to operate a hub-spoke Very Small Aperture Terminal (VSAT) with a signal hub earth station and 20 remote sites over X-Band geostationary satellite repeating relay with 54 MHz transponders. The allocated satellite bandwidth is 54 MHz and each carrier signal is assigned to operate with 2.7 MHz of spectrum. The bandwidth is allocated as 54/54 MHz or 100.00%. However, the power is allocated at 100.00% of the available power of the transponder. The net result is that the PEB is allocated at 54/54 or 54/54=100.00%. In the baseline configuration, each site uses 5.00% of the allocated PEB. For this example, one site requires an increase in bandwidth resulting in the power having to be increased to the one site of 10.00%. The result is that half of the PEB will need to be allocated to this one site while the remaining sites being decreased by this amount. The redistribution of power is: power to the high bandwidth site being 10.00% and 4.73% to the remaining 19 sites. Therefore, the power is distributed as 10.00%+19*4.73%=89.87% of the power, which maintains the PEB to the contracted amount. When the power is adjusted and the MODCODs are changed, no interruption to the service is experienced.

### EXAMPLE 10

In particular implementations of the system described in Example 9, the satellite uses C-Band resulting in the same allocation of PEB.

### EXAMPLE 11

In particular implementations of the system described in Example 9, the satellite uses Ku-Band resulting in the same allocation of PEB.

### EXAMPLE 12

In particular implementations of the system described in Example 9, the satellite uses Ka-Band resulting in the same allocation of PEB.

### EXAMPLE 13

A satellite network is configured to operate a hub-spoke Very Small Aperture Terminal (VSAT) with a signal hub earth station and 20 remote sites over X-Band geostationary satellite repeating relay with 54 MHz transponders. The allocated satellite bandwidth is 54 MHz and each carrier is assigned to operate with 2.7 MHz of spectrum. The bandwidth is allocated as 54/54 MHz or 100.00%. The net result is that the PEB is allocated at 54/54 or 54/54=100.00%. For this example, the power is allocated at 100.00% of the available power of the transponder. However, the configuration is going to operate at less than 100% power, e.g. the network will be operating at 80% power until a site requires additional bandwidth. In the baseline configuration, each site uses 4.00% of the allocated PEB for a total of 80% of the power (20 sites*4.00%=80.00%). For this example, one site requires an increase in bandwidth resulting in the power having to be increased to the one site of 10.00%. The result is 10.00% of the PEB will need to be allocated to this one site while the remaining sites remain at 4.00%. The power is not distributed for 19 sites, but remains constant, and one site is increased from 4.00% to 10.00%. Therefore, the power is distributed as 1*10.00%+19*4.00%=86.00% of the power. This leaves an additional 14.00% of PEB for use by other sites. When the power is adjusted and the MODCODs are changed, no interruption to the service is experienced.

### EXAMPLE 14

In particular implementations of the system described in Example 13, the satellite uses C-Band resulting in the same allocation of PEB.

### EXAMPLE 15

In particular implementations of the system described in Example 13, the satellite uses Ku-Band resulting in the same allocation of PEB.

### EXAMPLE 16

In particular implementations of the system described in Example 13, the satellite uses Ka-Band resulting in the same allocation of PEB.

In places where the description above refers to particular implementations of telecommunication systems and techniques for transmitting data across a telecommunication channel, it should be readily apparent that a number of modifications may be made without departing from the spirit thereof and that these implementations may be applied to other to telecommunication systems and techniques for transmitting data across a telecommunication channel.

1. A method of controlling bandwidth allocation over a communications link, the method comprising:
detecting, by a processor, a change in a power level of a composite signal transmitted by a transmitter, the composite signal comprising a plurality of carrier signals and having a constant center frequency and spectral allocation;
adjusting at least one of a modulation factor and a forward error correction (FEC) rate of one or more of the plurality of carrier signals using a modulator, in response to the change in power level to maintain a predetermined data rate and spectral allocation of the composite signal; and
maintaining, by the modulator, an uninterrupted communications link between the transmitter and a remote receiver while the at least one of the modulation factor and the FEC rate is adjusted.

2. The method of claim 1, wherein the at least one of the modulation factor and the FEC rate of only one carrier signal among the plurality of carrier signals is adjusted.

3. The method of claim 1, wherein the at least one of the modulation factor and the FEC rate of two or more carrier signals among the plurality of carrier signals is adjusted.

4. The method of claim 1, further comprising:
reducing, by a single remote receiver, the power level and corresponding data rate required by the single remote receiver; and
reducing, by the modulator, the at least one of the modulation factor and FEC rate such that the communications link between the transmitter and single remote receiver remains a closed link.

5. The method of claim 1, further comprising:
reducing, by a plurality of remote receivers, the power level and corresponding data rate required by the plurality of remote receivers; and
reducing, by the modulator, the at least one of the modulation factor and FEC rate such that the communications links between the transmitter and the plurality of remote receivers remain closed links.

6. The method of claim 1, further comprising:
increasing, by a single remote receiver, the power level and corresponding data rate required by the single remote receiver; and
increasing, by the modulator, the at least one of the modulation factor and FEC rate such that the communications link between the transmitter and single remote receiver remains a closed link.

7. The method of claim 1, further comprising:
increasing, by a plurality of remote receivers, the power level and corresponding data rate required by the plurality of remote receivers; and
increasing, by the modulator, the at least one of the modulation factor and FEC rate such that the communications links between the transmitter and the plurality of remote receivers remain closed links.

8. The method of claim 1, further comprising adjusting the at least one of the modulation factor and FEC rate using adaptive coding and modulation (ACM).

9. The method of claim 8, further comprising maintaining a power equivalent bandwidth (PEB) for a single carrier signal among the plurality of carrier signals.

10. The method of claim 8, further comprising maintaining a constant occupied bandwidth for each carrier signal among the plurality of carrier signals using a constant symbol rate configuration.

11. The method of claim 1, further comprising transmitting, by a hub, control information to one or more remote receivers, the control information comprising information about at least one of a required power level, modulation factor, and FEC rate.

12. The method of claim 1, further comprising maintaining a constant power equivalent bandwidth (PEB) for the composite carrier signal.

13. The method of claim 12, further comprising adjusting the at least one of the modulation factor and FEC rate using adaptive coding and modulation (ACM).

14. The method of claim 13, further comprising:
maintaining a constant occupied bandwidth for each carrier signal among the plurality of carrier signals using a constant symbol rate configuration; and
adjusting a power level of the transmitter such that the composite carrier signal has a PEB that is less than a maximum allowable PEB.

15. The method of claim 12, further comprising transmitting, by a hub, control information to one or more remote receivers, the control information comprising information about at least one of a required power level, modulation factor, and FEC rate.

16. The method of claim 12, further comprising:
monitoring, by a plurality of remote receivers, a PEB of the plurality of carrier signals; and
controlling, by each of the remote receivers among the plurality of remote receivers, at least one of a power level, modulation factor and FEC rate of the remote receiver based on a contribution to the PEB of the plurality of carrier signals made by the remote receiver.

17. The method of claim 12, further comprising determining an optimal combination of power level and data rate for a remote receiver based on a predetermined data rate and one or more network requirements.

18. The method of claim 17, further comprising:
measuring, by a hub, a power contribution of each remote receiver; and
adjusting, by the hub, at least one of the power level, modulation factor, and FEC rate of one or more remote receivers to achieve a predetermined PEB for the network.

19. The method of claim 17, further comprising:
measuring, by a hub, a required bandwidth request of each remote receiver; and
adjusting, by the hub, at least one of the power level, modulation factor, and FEC rate of one or more remote receivers to achieve a predetermined PEB and data rate for the network.

20. The method of claim 1, further comprising adjusting one or more filter roll-offs or excess bandwidth of one or more carrier signals while maintaining a power equivalent bandwidth (PEB) of the one or more carrier signals.

21. The method of claim 12, further comprising increasing a power level of one or more remote transmitters by adjusting at least one of a power level, modulation factor, and FEC rate of a hub.

22. The method of claim 12, further comprising receiving, by a hub, information about a PEB of a network from an external measuring device.

23. The method of claim 12, further comprising receiving by one or more remote receivers, information about a PEB of a network from an external measuring device.

24. The method of claim 12, further comprising:
receiving, by a hub, information about a PEB of a network from an external measuring device; and
receiving by one or more remote receivers, information about the PEB of the network from the external measuring device.

25. A system for controlling bandwidth allocation over a communications link, the system comprising:
a transmitter;
a remote receiver;
a processor configured to detect a change in a power level of a composite signal transmitted by the transmitter, the composite signal comprising a plurality of carrier signals and having a constant center frequency and spectral allocation; and
a modulator configured to:
adjust at least one of a modulation factor and a forward error correction (FEC) rate of one or more of the plurality of carrier signals in response to the change in power level to maintain a predetermined data rate and spectral allocation of the composite signal; and
maintain an uninterrupted communications link between the transmitter and the remote receiver while the at least one of the modulation factor and the FEC rate is adjusted.

26. The system of claim 25, wherein the modulator is further configured to adjust the at least one of the modulation factor and the FEC rate of only one carrier signal among the plurality of carrier signals.

27. The system of claim 25, wherein the modulator is further configured to adjust the at least one of the modulation factor and the FEC rate of two or more carrier signals among the plurality of carrier signals.

28. The system of claim 25, wherein the remote receiver is a single remote receiver and is configured to reduce the power level and corresponding data rate required by the single remote receiver, and wherein the modulator is further configured to reduce at least one of the modulation factor and FEC rate such that the communications link between the transmitter and single remote receiver remains a closed link.

29. The system of claim 25, wherein the remote receiver comprises a plurality of remote receivers that are configured to reduce the power level and corresponding data rate required by the plurality of remote receivers, and wherein the modulator is further configured to reduce at least one of the modulation factor and FEC rate such that the communications links between the transmitter and plurality of remote receivers remain a closed links.

30. The system of claim 25, wherein the remote receiver is a single remote receiver and is configured to increase the power level and corresponding data rate required by the single remote receiver, and wherein the modulator is further configured to increase at least one of the modulation factor and FEC rate such that the communications link between the transmitter and single remote receiver remains a closed link.

31. The system of claim 25, wherein the remote receiver comprises a plurality of remote receivers that are configured to increase the power level and corresponding data rate required by the plurality of remote receivers, and wherein the modulator is further configured to increase at least one of the modulation factor and FEC rate such that the communications links between the transmitter and plurality of remote receivers remain closed links.

32. The system of claim 25, wherein the modulator is further configured to adjust the at least one of the modulation factor and FEC rate using adaptive coding and modulation (ACM).

33. The system of claim 32, wherein the modulator is further configured to maintain a power equivalent bandwidth (PEB) for a single carrier signal among the plurality of carrier signals.

34. The system of claim 32, wherein the modulator is further configured to maintain a constant occupied bandwidth for each carrier signal among the plurality of carrier signals using a constant symbol rate configuration.

35. The system of claim 25, further comprising a hub configured to transmit control information to one or more remote receivers, the control information comprising information about at least one of a required power level, modulation factor, and FEC rate.

36. The system of claim 25, wherein a constant power equivalent bandwidth (PEB) for the composite carrier signal is maintained.

37. The system of claim 36 wherein the modulator is further configured to adjust the at least one of the modulation factor and FEC rate using adaptive coding and modulation (ACM).

38. The system of claim 37, wherein the modulator is further configured to:
maintain a constant occupied bandwidth for each carrier signal among the plurality of carrier signals using a constant symbol rate configuration; and
adjust a power level of the transmitter such that the composite carrier signal has a PEB that is less than a maximum allowable PEB.

39. The system of claim 36, further comprising a hub configured to transmit control information to one or more remote receivers, the control information comprising information about at least one of a required power level, modulation factor, and FEC rate.

40. The system of claim 36, further comprising a plurality of remote receivers configured to monitor a PEB of the plurality of carrier signals and control at least one of a power level, modulation factor and FEC rate of the remote receiver based on a contribution to the PEB of the plurality of carrier signals made by the remote receiver.

41. The system of claim 36, wherein the remote receiver is configured to determine an optimal combination of power level and data rate for the remote receiver based on a predetermined data rate and one or more network requirements.

42. The system of claim 41, further comprising a hub configured to measure a power contribution of each remote receiver and adjust at least one of the power level, modulation factor, and FEC rate of one or more remote receivers to achieve a predetermined PEB for the network.

43. The system of claim 41, further comprising a hub configured to measure a required bandwidth request of each remote receiver and adjust at least one of the power level, modulation factor, and FEC rate of one or more remote receivers to achieve a predetermined PEB and data rate for the network.

44. The system of claim 36, wherein the hub is further configured to increase a power level of one or more remote transmitters by adjusting at least one of a power level, modulation factor, and FEC rate of the hub.

45. The system of claim 25, wherein the modulator is further configured to adjust one or more filter roll-offs or excess bandwidth of one or more carrier signals while maintaining a power equivalent bandwidth (PEB) of the one or more carrier signals.

46. The system of claim 36, wherein the hub is further configured to receive information about a PEB of a network from an external measuring device.

47. The system of claim 36, further comprising one or more remote receivers configured to receive information about a PEB of a network from an external measuring device.

48. The system of claim 36, wherein the hub is further configured to receive information 46 about a PEB of a network from an external measuring device and wherein one or more remote receivers is configured to receive information about the PEB of the network from the external measuring device.
